(19) United States
(12) Patent Application Publication
(10) Pub. No.: US 2016/0242386 A1
(43) Pub. Date: Aug. 25, 2016

(54) RESTRAINT SYSTEM FOR AN ANIMAL

(71) Applicant: The Pet Salon, Inc., Margate, NJ (US)

(72) Inventor: Charles Ross Simons, Margate, NJ (US)

(21) Appl. No.: 14/625,936

(22) Filed: Feb. 19, 2015

(51) Int. Cl. A01K 13/00

(52) U.S. Cl. CPC A01K 13/001

(57) ABSTRACT

A restraint system for an animal includes a bottom frame with a perforated support surface affixed atop the bottom frame. A first riser arm is affixed to a first side of the bottom frame, and a second riser arm is affixed to a second side of the bottom frame, with the first side being opposite the second side. A cross arm is coupled between the first riser arm and the second riser arm, the first and second riser arms supporting the cross arm above the perforated support surface. A first upper coupler is affixed to the cross arm, and a first side coupler is affixed to one of the first riser arm and the second riser arm. A first restraining loop is configured to be placed around a neck of a first animal and to cross tie between the first upper coupler and the first side coupler.

### FIELD OF THE INVENTION

The field of the present invention relates to a restraint system for an animal, particularly a restraint system which may be employed within a wash basin and used while an animal is washed.

### BACKGROUND OF THE INVENTION

Pet groomers and pet owners alike generally recognize the benefits of periodic baths for their animals, particularly for dogs, although other animals may also benefit from periodic washing. Regardless of whether a pet is washed by a professional groomer or at home, the pet is typically placed in a wash basin, a sink, a bath tub, or a similar structure (collectively referred to herein as a “wash basin”) for washing. Washing a pet can lead to discomfort and anxiety for the pet, and a pet which is experiencing discomfort or anxiety places the groomer or pet owner at a higher risk of being bitten. At the same time, a pet experiencing discomfort or anxiety during a wash also places the pet at an increased risk of injury, and the risk of injury is only increased if the pet is restrained improperly within the wash basin.

In order to reduce the incidents of pets biting while they are being washed, specially designed wash basins have been developed in which a pet may be restrained within the wash basin. A problem with such wash basins is that they are designed as wash basins with a restraint system “bolted” on as an afterthought—and so the restraint system may be less than ideal. Moreover, because such wash basins require the user, whether a pet groomer or a pet owner, to invest in a whole new wash basin in order to gain the benefit of having the restraint system, many choose not to incur the costs of such an investment.

As a result, many pet groomers and pet owners have turned to after market restraint systems, to be used in conjunction with already-owned wash basins, in order to gain the recognized benefits of a pet restraint while washing the pet. Such after market restraint systems come in all types. One example of such a restraint system is described in U.S. Pat. No. 4,316,433. This restraint system includes a washing stand which fits into the bottom of a sink, so that the pet can stand on the washing stand, and a tether rises up from the washing stand to go around the pet's neck. Another example of a restraint system is described in U.S. Pat. No. 5,373,814. This restraint system discloses multiple tethers that attach to a pet's collar, each tether affixes to a suction cup, and the suction cups secure the tethers to the sides of the wash basin. Other versions of restraint systems that employ one or more tethers affixed to suction cups are also known. Yet another example of a restraint system is described in U.S. Pat. No. 7,219,625. This restraint system discloses a container having a lid with holes in it, with the pet being placed on the lid for washing, and a restraining bar is attached to the container, the restraining bar extending above the pet's head so that a restraining loop may secure the pet from overhead. Each of these after market restraint systems has shortcomings insofar as facilitating the washing environment for the pet and restraining the pet so as to minimize the discomfort and anxiety of the animal and increase safety of the groomer or pet owner.

### SUMMARY OF THE INVENTION

The present invention is directed toward a restraint system for an animal. The restraint system may be advantageously used in a wash basin for when an animal is being washed. Advantageously, the restraint system may enable a groomer or pet owner to cross tie various sizes of animals while keeping the paws of a restrained animal out of pooling water in a wash basin.

In a first separate aspect of the present invention, a restraint system for an animal includes: a bottom frame; a perforated support surface affixed atop the bottom frame; a first riser arm affixed to a first side of the bottom frame; a second riser arm affixed to a second side of the bottom frame, the first side being opposite the second side; a cross arm coupled between the first riser arm and the second riser arm, the first and second riser arms supporting the cross arm above the perforated support surface; a first upper coupler affixed to the cross arm; a first side coupler affixed to one of the first riser arm and the second riser arm; and a first restraining loop configured to be placed around a neck of a first animal and to cross tie between the first upper coupler and the first side coupler.

In a second separate aspect of the present invention, a restraint system for an animal includes: a bottom frame; a perforated support surface affixed atop the bottom frame, the perforated support surface comprising a first surface section and a second surface section, wherein the first surface section is disposed in a first plane and the second surface section is disposed in a second plane, wherein the first and second planes are parallel and not coplanar; a first riser arm affixed to a first side of the bottom frame; a second riser arm affixed to a second side of the bottom frame, the first side being opposite the second side; a cross arm coupled between the first riser arm and the second riser arm, the first and second riser arms supporting the cross arm above the perforated support surface; a first upper coupler affixed to the cross arm; a first side coupler affixed to one of the first riser arm and the second riser arm; and a first restraining loop configured to be placed around a neck of a first animal and to cross tie between the first upper coupler and the first side coupler.

In a third separate aspect of the present invention, a restraint system for an animal includes: a bottom frame; a perforated support surface affixed atop the bottom frame; a first riser arm affixed to a first side of the bottom frame; a second riser arm affixed to a second side of the bottom frame, the first side being opposite the second side; a cross arm coupled between the first riser arm and the second riser arm, the first and second riser arms supporting the cross arm above the perforated support surface; a first upper coupler affixed to the cross arm; a second upper coupler affixed to the cross arm; a first side coupler affixed to one of the first riser arm and the second riser arm, wherein the first side coupler is slidably coupled to the one of the first riser arm and the second riser arm, and the first side coupler is configured to be secured in a fixed position on the respective first or second riser arm; a second side coupler affixed to the other of the first riser arm and the second riser arm, wherein the second side coupler is slidably coupled to the other of the first riser arm and the second riser arm, and the second side coupler is configured to be secured in a fixed position on the respective first or second riser arm; and a first restraining loop configured to be placed around a neck of a first animal and to cross tie between the first upper coupler and the first side coupler.

Accordingly, an improved animal restraint is disclosed. Advantages of the improvements will be apparent from the drawings and the description of the preferred embodiment.

### BRIEF DESCRIPTION OF THE DRAWINGS

The foregoing summary, as well as the following detailed description of the exemplary embodiments, will be better understood when read in conjunction with the appended drawings. It should be understood, however, that the invention is not limited to the precise arrangements and instrumentalities shown in the following figures:

FIG. 1 is a perspective view of a first restraint system for an animal;

FIG. 2 is a perspective view of the first restraint system with the perforated support surface removed to show the bottom frame 15;

FIG. 3 is a front elevation view of the restraint system of FIG. 1;

FIG. 4A is a perspective view of a first embodiment of an arm clamp body;

FIG. 4B is a top plan view of the arm clamp body of FIG. 3A;

FIG. 4C is a sectional view of the arm clamp body along the line IIIC-IIIC of FIG. 4B;

FIG. 4D is a sectional view of the arm clamp body along the line IIID-IIID of FIG. 4B; and

FIG. 5 is a perspective view of a third restraint system for an animal.

### DETAILED DESCRIPTION OF THE INVENTION

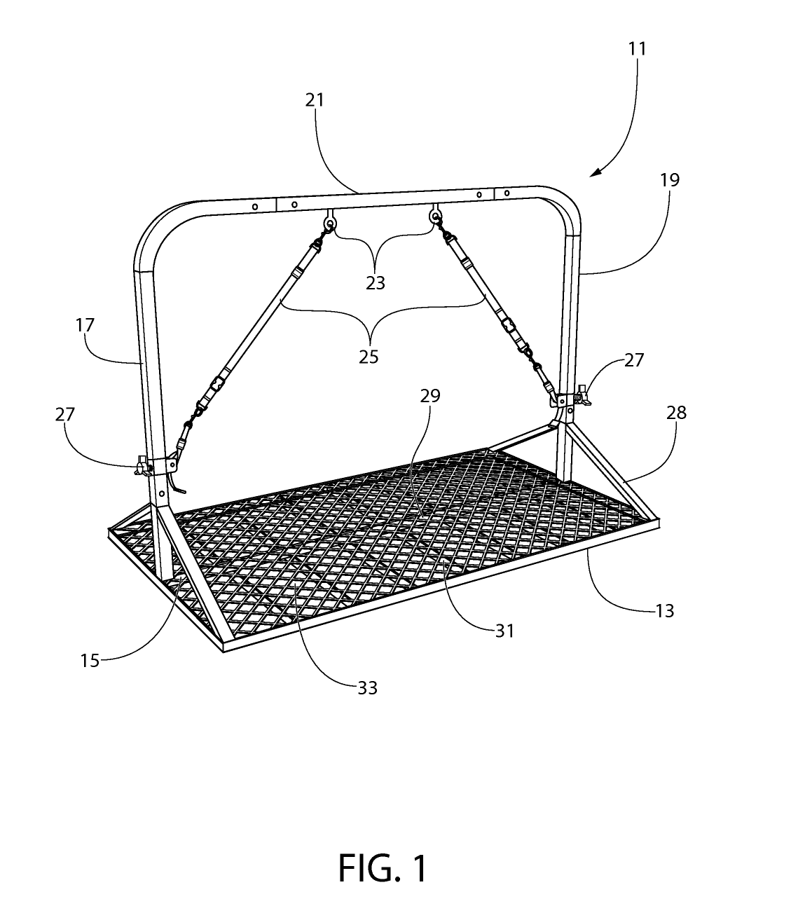

Turning in detail to the drawings, FIG. 1 illustrates restraint system 11 for an animal. This restraint system 11 is one that is particularly well suited for use within a wash basin to wash an animal, although it may also be used free standing or on other support surfaces. A perforated support surface 13 is affixed atop a bottom frame 15. A first riser arm 17 is affixed to and extends upward from a first side of the bottom frame 15, and a second riser arm 19 is affixed to and extends upward from a second side of the bottom frame 15, with the first and second sides being opposite each other. In order to maximize free space for an animal when the restraint system 11 is placed within a wash basin, the first and second riser arms 17, 19 are positioned in approximately the center the respective first and second sides of the bottom frame 15. Of course, alternative placements for the first and second riser arms 17, 19 may also be used. In addition, the first and second riser arms 17, 19 need not be symmetrically placed. A cross arm 21 is coupled between the first riser arm 17 and the second riser arm 19. The cross arm 21 includes two upper couplers 23 which serve as upper connection points for the restraining loops 25. Each of the first and second riser arms 17, 19 include side couplers 27 which serve as side connection points so that the restraining loops 25 may be cross tied between the upper couplers 23 and the respective side couplers 27.

The bottom frame 15 is constructed to provide a support base for the first and second riser arms 17, 19 and a platform for the perforated support surface 13. As such, the bottom frame is rigidly constructed. To provide additional support to the first and second riser arms 17, 19, buttresses 28 may be included between each of the first and second riser arms 17, 19 and the bottom frame 15. In certain embodiments, additional struts may be added to the first and second riser arms 17, 19 to provide additional stability, particularly when the restraint system 11 is used within a wash basin. For example, struts may be added to the first and second riser arms 17, 19 that extend toward extending per

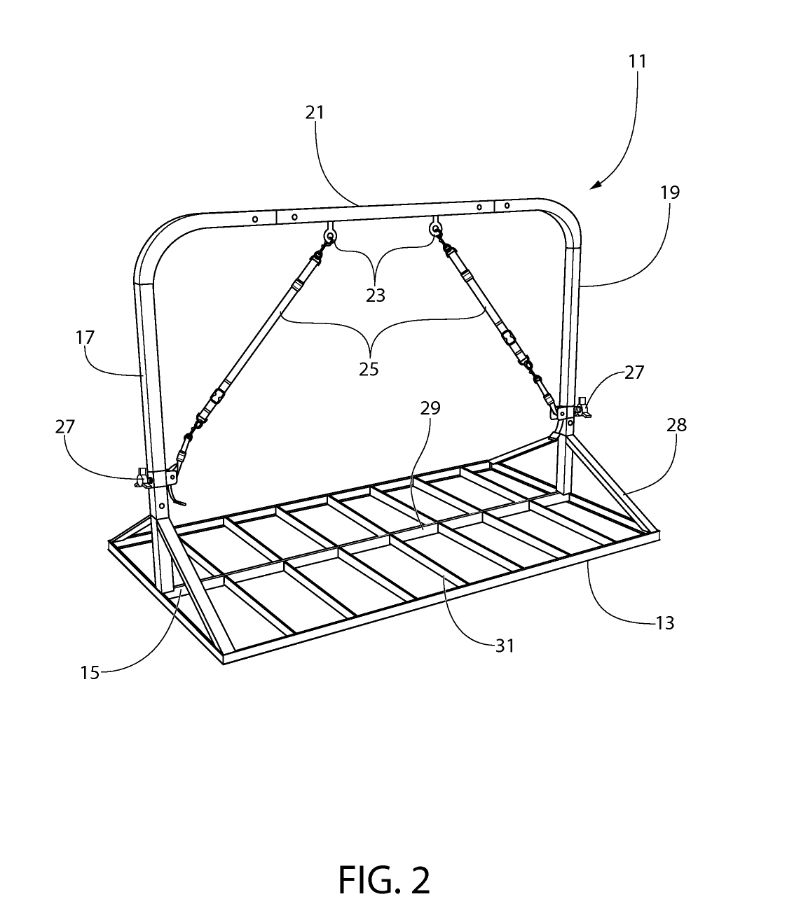

As shown in FIG. 2, the bottom frame 15 is formed of a longitudinal beam 29 secured at one end to the first riser arm 17 and at the other end to the second riser arm 19. A plurality of transverse ribs 31 are secured to the longitudinal beam 29 so that the bottom frame forms a base to which the perforated support surface 13 is secured. In embodiments of the restraint system 11 intended to be used in a wash basin, the longitudinal beam 29 and the transverse ribs 31 should be made out of a material that will not be corroded or rusted by water or the chemicals used for washing an animal. By way of example, both the longitudinal beam 29 and the transverse ribs 31 may be constructed from stainless steel square tubing that is welded in the desired configuration to support the perforated support surface 13.

In certain embodiments, additional struts may be added to the first and second riser arms 17, 19 to provide additional stability, particularly when the restraint system 11 is used within a wash basin. For example, struts may be added to the first and second riser arms 17, 19 that extend perpendicular to the longitudinal beam. Such a strut may be long enough to contact a rear wall of a wash basin to provide additional stability, if such is needed or desired.

The bottom portion of the bottom frame 15 includes a plurality of flow regions 33 for the flowing of a liquid under the top of the support surface 13. In the restraint system 11 of FIGS. 1 and 2, the bottom surface of the perforated support surface 13 is separated from the top surface of the bottom frame 15 by spacers (not shown) to create a gap between the bottom surface of the perforated support surface 13 and the top surface of the bottom frame 15. This gap enables liquid to flow between the various adjacent flow regions 33. Enabling liquid to flow between the flow regions is especially important when the restraint system 11 is placed within a wash basin, so that the liquid can flow to the drain without the animal standing in the liquid, which can potentially contain chemicals, such as shampoos or flea and/or tick treatments, that may negatively impact the animal by prolonged contact with the paws. In alternative configurations, the bottom frame 15 itself may be configured with curved portions, feet, risers, and the like to create the one or more flow channels. In configurations in which feet or risers are included, such feet or risers may be made of a material that will provide scratch and/or surface protection for when the restraint system is used in a wash basin.

The perforated support surface 13 is also constructed out of a material that will not be corroded or rusted by water or the chemicals used for washing an animal. Optionally, the perforated support surface 13 may be constructed from an alternative core material, one which at least provide sufficient strength to support an animal, with the core material having an exterior coating that is resistant to corrosion or rust and protects the core material from corrosion or rust. The perforated support surface 13 provides a sufficiently stable surface on which an animal may stand, yet has perforations that are sufficiently numerous and sized to allow a liquid and small dirt, debris, and fur to pass as an animal is washed.

Both the first and second riser arms 17, 19 extend upward from the bottom frame 15 to support the cross arm 21. The combination of the first and second riser arms 17, 19 and the cross arm 21 may be constructed from any number of segments, and all may be constructed from a tubular material, such as a stainless steel tube. As shown, the cross arm 21 is in a fixed position relative to the first and second riser arms 17, 19, however in alternative embodiments, the cross arm 21 may be movably affixed to the first and second riser arms 17, 19 so that the height of the cross arm 21 above the perforated support surface 13 is adjustable. Each of the first and second riser arms 17, 19 has a side coupler 27 affixed thereto. The side couplers 27 are shown as arm clamps, as such arm clamps are height adjustable on the respective first and second riser arms 17, 19. One embodiment of such arm clamps is described in greater detail below. Other types of side couplers 27 may be used, such as eye bolts, hooks, swivel clasps, and the like. Both of the side couplers 27 need not be the same type of coupler. By using an arm clamp as a side coupler 27 on one or both of the first and second riser arms 17, 19, the side coupler 27 is then slidably coupled to and may be secured in a fixed position on the respective one of the first and second riser arms 17, 19.

The upper couplers 23 are shown as eyebolts extending downward from the cross arm 21. Other types of upper couplers 23 may be used, such as arm clamps, hooks, swivel clasps, and the like. Both of the upper couplers 23 need not be the same type of coupler. By using one or more arm clamps as upper couplers 23 on the cross arm 21, the upper coupler 23 is then slidably coupled to and may be secured in a fixed position on the cross arm 21, thereby providing for greater versatility of use with animals of differing sizes.

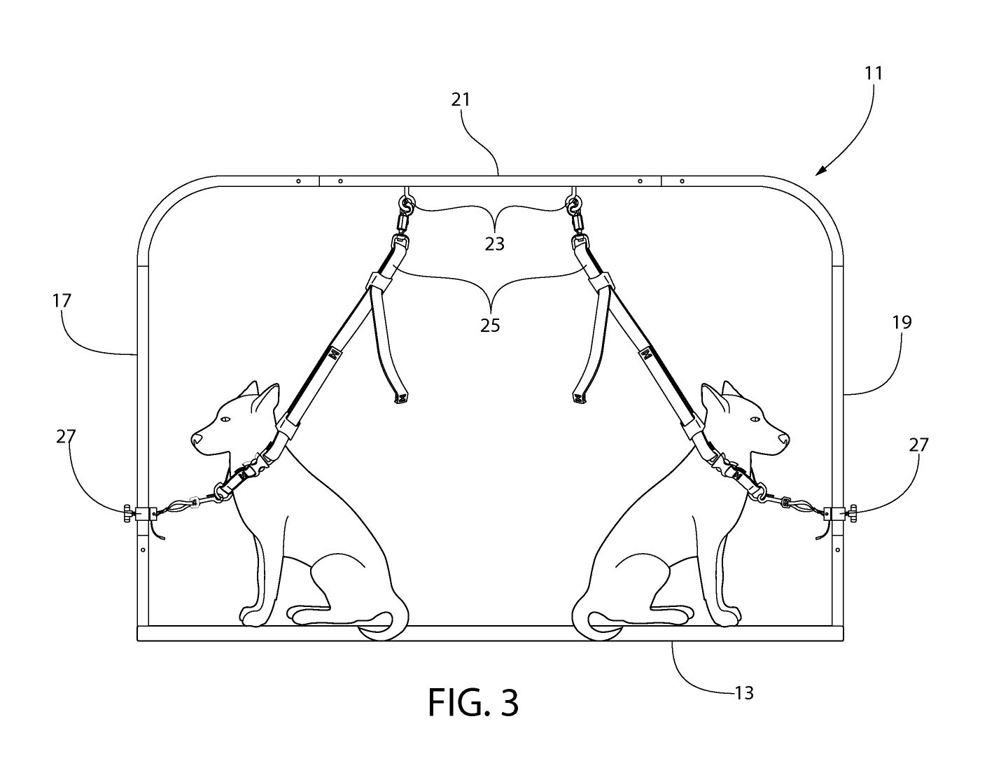

In some configurations, the side coupler 27 and upper coupler 23 on one side of the restraint system 11 may be omitted. As shown in FIG. 3, when both the first and second riser arms 17, 19 include side couplers 27 and the cross arm 21 includes two upper couplers 23, the restraint system 11 may be used to safely secure two dogs simultaneously, thereby enabling both to be groomed and/or washed at the same time. Alternatively, the restraint system 11 may advantageously be used within a wash basin so that a groomer or pet owner may easily groom and/or wash one side of the animal while the animal is cross tied toward the first riser arm 17, and then groom and/or wash the other side of the animal while the animal is cross tied toward the second riser arm 19.

One embodiment of the restraining loop 25 that may be advantageously used with the restraint system 11 is shown and described in U.S. Pat. No. 8,365,685 and in U.S. Pat. No. 8,925,496, the disclosures of which are incorporated herein by reference in their entirety. Those of skill in the art will recognize that the restraining loop 25 is placed around the neck of an animal, without placing pressure on the throat, so that the animal may be cross tied using the restraint system 11 as described herein. Those of skill in the art will also recognize that the restraining loop 25 may take many different forms and still be useable as part of the restraint system 11.

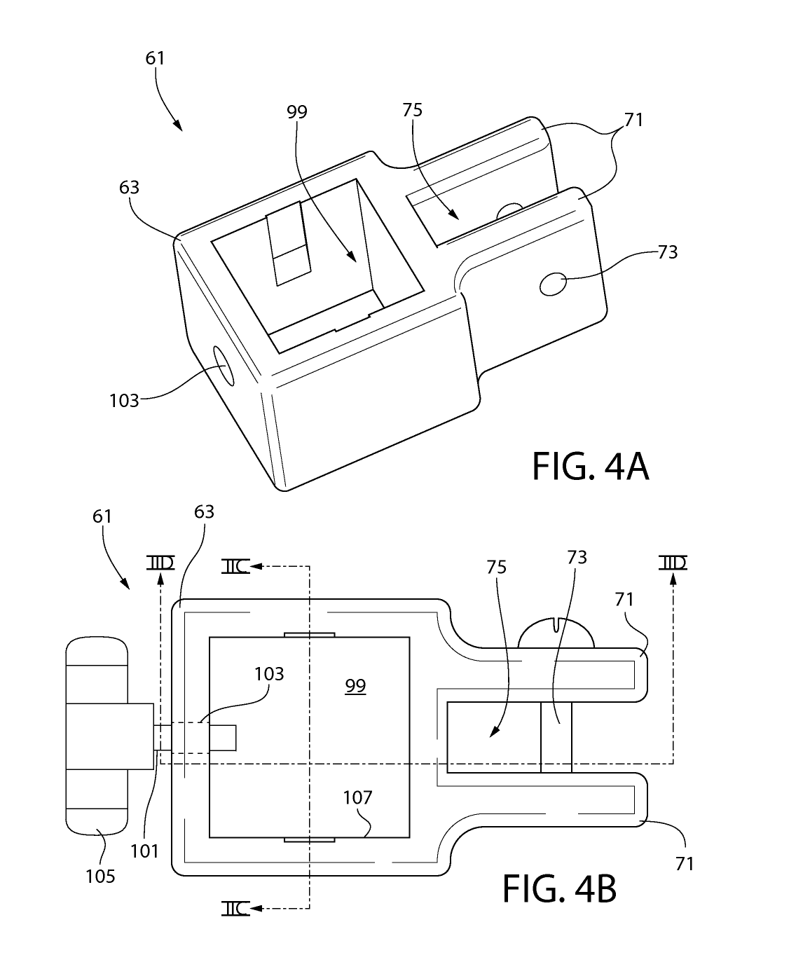

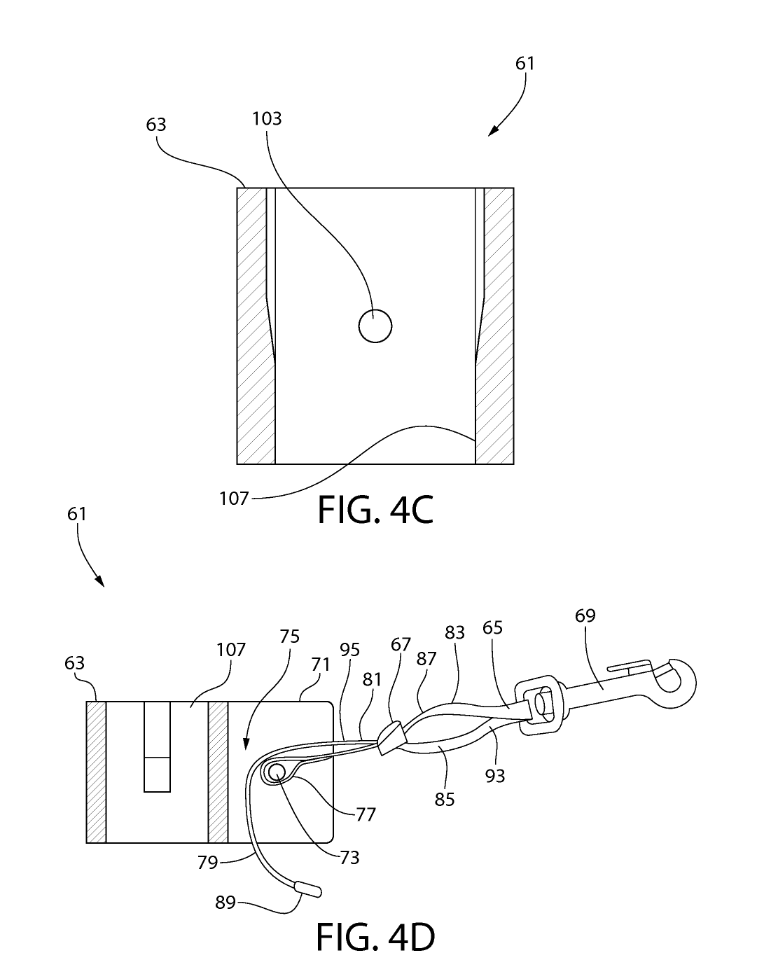

One embodiment of an arm clamp 61 that may be used as part of a restraint system is illustrated in FIGS. 4A-D. The arm clamp 61 includes a clamp body 63, a tether 65, a tether clamp 67, and a tether connector 69. Referring to FIGS. 4A and 4B, the clamp body 63 includes two outward-extending arms 71, which are spaced apart from one another, and a tether anchor 73 coupled between the two arms 71. A tether guide 75 is formed as an aperture bordered on each of three sides respectively by the two arms 71 and the tether anchor 73. The tether guide 75 may be bordered on the fourth side by a portion of the clamp body 63 or by the securing arm to which the clamp body 63 is affixed.

The tether 65 includes a first tether end 77 coupled to the tether anchor 73 and a second tether end 79 which extends through the tether guide 75. The middle portion 81 of the tether 65 forms a tether loop 83 having a first loop side 85 extending from the first tether end 77 and a second loop side 87 extending from the second tether end 79 through the tether guide 75. The second tether end 79 includes a stopper 89, which may be a knot formed at the second tether end 79 or a metal or plastic end cap attached to the second tether end 79. The stopper 89 has at least one cross-sectional dimension that is larger than a cross-sectional dimension of the aperture forming the tether guide 75 so that the second tether end 79 does not pass through the tether guide 75. The stopper 89 may also be shaped so that as it is drawn between the two outward-extending arms 71, the stopper 89 is forced to rotate by the two outward-extending arms 71 so that the cross-sectional dimension of the stopper 89 that is larger is aligned with a smaller cross-sectional dimension of the aperture forming the tether guide 75, thereby preventing the stopper 89 from passing through the aperture. With such a configuration, the second tether end 79 remains in position for the user to pull when desired. The tether 65 may be made of a material such as nylon webbing, polyester webbing, cotton webbing, cloth, or any other desired material appropriate for a particular usage.

The tether clamp 67 is slidably disposed over the first and second loop sides 85, 87, dividing the tether loop 83 into a primary tether loop 93 and a secondary tether loop 95, with the tether clamp 67 maintaining the size of the primary tether loop 93. The tether connector 69 is slidably coupled to the primary tether loop 93 for coupling the tether 65 to one of the connectors of the restraining loop 25.

The relative positions of the tether anchor 73 and the tether guide 75 maintain substantial alignment between the first loop side 85 and the second loop side 87 when the loop 83 is tensioned, and the enlarged stopper at the second tether end 79 helps ensure that this substantial alignment configuration is maintained during use of the arm clamp 61. The loop 83 is tensioned when at least one of the first or second loop sides 85, 87 is tensioned, and generally only the first loop side 85 will be tensioned when an animal is placed within the restraining loop 25. By having substantial alignment between the first loop side 85 and the second loop side 87 when the loop 83 is tensioned, a groomer or pet owner may pull on and tension the second tether end 79, drawing the second loop side 87 over the first tether end 77 and the tether anchor 73, so that the size of the primary tether loop 93 is decreased. Closure of the tether clamp 67 will maintain the reduced size of the primary tether loop 93, thereby better securing the animal for washing or grooming by increasing tension in the restraining loop 25.

The clamp body 63 forms an arm aperture 99 which is configured in size and shape to receive one of the securing arms. A threaded rod 101 threadably engages a threaded through hole 103 in the clamp body 63 to enable the clamp body to be secured in place on a securing arm. A handle 105 is affixed to the end of the threaded rod 101 so that the threaded rod 101 may be rotated by hand. In certain embodiments, the clamp body 63 may be configured to extend only partially around a securing arm, while still effectively forming an arm aperture and having a threaded rod engaging the clamp body to secure the clamp body 63 to a securing arm.

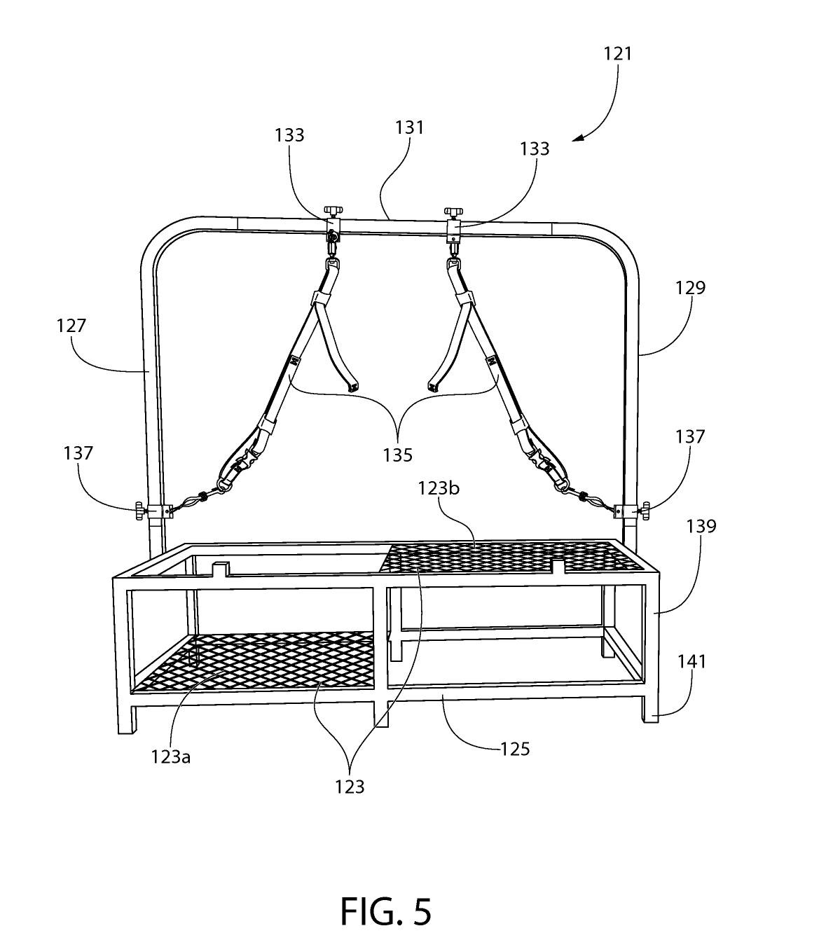

A second embodiment of a restraint system 121 is illustrated in FIG. 5. A perforated support surface 123 is affixed to a bottom frame 125 to create one side of the restraint system 121 with a lower level support surface 123a and the other side with an upper level support surface 123b. A first riser arm 127 is affixed to and extends upward from a first side of the bottom frame 125, and a second riser arm 129 is affixed to and extends upward from a second side of the bottom frame 125, with the first and second sides being opposite each other. In order to maximize free space for an animal when the restraint system 121 is placed within a wash basin, the first and second riser arms 127, 129 are positioned in approximately the center the respective first and second sides of the bottom frame 125. Of course, alternative placements for the first and second riser arms 127, 129 may also be used. In addition, the first and second riser arms 127, 129 need not be symmetrically placed. A cross arm 131 is coupled between the first riser arm 127 and the second riser arm 129. The cross arm 131 includes two upper couplers 133 which serve as upper connection points for the restraining loops 135. Each of the first and second riser arms 127, 129 include side couplers 137 which serve as side connection points for purposes of cross-tying the restraining loops 135.

The bottom frame 125 is constructed to provide a support base for the first and second riser arms 127, 129 and a mutli-level platform for the perforated support surface 123. As such, the bottom frame is rigidly constructed. As shown in FIG. 5, the bottom frame 125 is formed as a box frame 139 with short riser legs 141 supporting the box frame 139. The box frame 139 provides multiple support levels to which the perforated support surface 123 to create the lower level support surface 123a and the upper level support surface 123b. Additional structure may be added to the box frame 139 to create additional support levels. The riser legs 141 serve to elevate the bottom of the box frame 139 sufficiently to effectively create a single flow channel under the restraint system 121. This enables liquid to flow freely underneath the box frame 139, which is especially important when the restraint system 121 is placed within a wash basin, so that the liquid can flow to the drain without the animal standing in the liquid. Alternatively, the box frame 139 may be constructed to have flow channels without inclusion of the riser legs 141.

Both the first and second riser arms 127, 129 extend upward from the bottom frame 125 to support the cross arm 131. The combination of the first and second riser arms 127, 129 and the cross arm 131 may be constructed from any number of segments, and all may be constructed from a tubular material, such as a stainless steel tube. As shown, the cross arm 131 is in a fixed position relative to the first and second riser arms 127, 129, however in alternative embodiments, the cross arm 131 may be movably affixed to the first and second riser arms 127, 129 so that the height of the cross arm 131 above the perforated support surface 123 is adjustable.

The side couplers 137 are shown as arm clamps, as such arm clamps are height adjustable on the respective first and second riser arms 127, 129. One embodiment of such arm clamps is described in greater detail below. Other types of side couplers 137 may be used, such as eye bolts, hooks, swivel clasps, and the like. Both of the side couplers 137 need not be the same type of coupler.

The upper couplers 133 are shown as arm clamps extending downward from the cross arm 131. Other types of upper couplers 133 may be used, such as eye bolts, hooks, swivel clasps, and the like. Both of the upper couplers 133 need not be the same type of coupler.

In some configurations, the side coupler 137 and upper coupler 133 on one side of the restraint system 121 may be omitted. The same types of restraining loops may be used with the restraint system 121 as shown with the restraint system 11 of FIG. 1.

While the invention has been described with respect to specific examples including presently preferred modes of carrying out the invention, those skilled in the art will appreciate that there are numerous variations and permutations of the above described systems and techniques. It is to be understood that other embodiments may be utilized and structural and functional modifications may be made without departing from the scope of the present invention. Thus, the spirit and scope of the invention should be construed broadly as set forth in the appended claims.

What is claimed is:

1. A restraint system for an animal, the system comprising:
a bottom frame;
a perforated support surface affixed atop the bottom frame;
a first riser arm affixed to a first side of the bottom frame;
a second riser arm affixed to a second side of the bottom frame, the first side being opposite the second side;
a cross arm coupled between the first riser arm and the second riser arm, the first and second riser arms supporting the cross arm above the perforated support surface;
a first upper coupler affixed to the cross arm;
a first side coupler affixed to one of the first riser arm and the second riser arm; and
a first restraining loop configured to be placed around a neck of a first animal and to cross tie between the first upper coupler and the first side coupler.

2. The restraint system of claim 1, wherein the first side coupler is slidably coupled to the one of the first riser arm and the second riser arm, and the first side coupler is configured to be secured in a fixed position on the respective first or second riser arm.

3. The restraint system of claim 1, wherein the first upper coupler is slidably coupled to the cross arm, and the first upper coupler is configured to be secured in a fixed position on the cross arm.

4. The restraint system of claim 1, further comprising:
a second upper coupler affixed to the cross arm; and
a second side coupler affixed to the other of the first riser arm and the second riser arm.

5. The restraint system of claim 4, further comprising a second restraining loop configured to be placed around a neck of a second animal and to cross tie between the second upper coupler and the second side coupler.

6. The restraint system of claim 4, wherein the second upper coupler is slidably coupled to the cross arm, and the second upper coupler is configured to be secured in a fixed position on the cross arm.

7. The restraint system of claim 4, wherein the second side coupler is slidably coupled to the other of the first riser arm and the second riser arm, and the second side coupler is configured to be secured in a fixed position on the respective first or second riser arm.

8. The restraint system of claim 1, wherein the perforated support surface is raised above a bottom of the bottom frame.

9. The restraint system of claim 1, wherein a bottom of the bottom frame forms one or more flow regions for the flowing of a liquid under a top of the support surface.

10. A restraint system for an animal, the system comprising:
a bottom frame;
a perforated support surface affixed atop the bottom frame, the perforated support surface comprising a first surface section and a second surface section, wherein the first surface section is disposed in a first plane and the second surface section is disposed in a second plane, wherein the first and second planes are parallel and not coplanar;
a first riser arm affixed to a first side of the bottom frame;
a second riser arm affixed to a second side of the bottom frame, the first side being opposite the second side;
a cross arm coupled between the first riser arm and the second riser arm, the first and second riser arms supporting the cross arm above the perforated support surface;
a first upper coupler affixed to the cross arm;
a first side coupler affixed to one of the first riser arm and the second riser arm; and
a first restraining loop configured to be placed around a neck of a first animal and to cross tie between the first upper coupler and the first side coupler.

11. The restraint system of claim 10, wherein the first side coupler is slidably coupled to the one of the first riser arm and the second riser arm, and the first side coupler is configured to be secured in a fixed position on the respective first or second riser arm.

12. The restraint system of claim 10, wherein the first upper coupler is slidably coupled to the cross arm, and the first upper coupler is configured to be secured in a fixed position on the cross arm.

13. The restraint system of claim 10, further comprising:
a second upper coupler affixed to the cross arm; and
a second side coupler affixed to the other of the first riser arm and the second riser arm.

14. The restraint system of claim 13, further comprising a second restraining loop configured to be placed around a neck of a second animal and to cross tie between the second upper coupler and the second side coupler.

15. The restraint system of claim 13, wherein the second upper coupler is slidably coupled to the cross arm, and the second upper coupler is configured to be secured in a fixed position on the cross arm.

16. The restraint system of claim 13, wherein the second side coupler is slidably coupled to the other of the first riser arm and the second riser arm, and the second side coupler is configured to be secured in a fixed position on the respective first or second riser arm.

17. The restraint system of claim 10, wherein the perforated support surface is raised above a bottom of the bottom frame.

18. The restraint system of claim 10, wherein a bottom of the bottom frame forms one or more flow regions for the flowing of a liquid under a top of the support surface.

19. A restraint system for an animal, the system comprising:
a bottom frame;
a perforated support surface affixed atop the bottom frame;
a first riser arm affixed to a first side of the bottom frame;
a second riser arm affixed to a second side of the bottom frame, the first side being opposite the second side;
a cross arm coupled between the first riser arm and the second riser arm, the first and second riser arms supporting the cross arm above the perforated support surface;
a first upper coupler affixed to the cross arm;
a second upper coupler affixed to the cross arm;
a first side coupler affixed to one of the first riser arm and the second riser arm, wherein the first side coupler is slidably coupled to the one of the first riser arm and the second riser arm, and the first side coupler is configured to be secured in a fixed position on the respective first or second riser arm;
a second side coupler affixed to the other of the first riser arm and the second riser arm, wherein the second side coupler is slidably coupled to the other of the first riser arm and the second riser arm, and the second side coupler is configured to be secured in a fixed position on the respective first or second riser arm; and
a first restraining loop configured to be placed around a neck of a first animal and to cross tie between the first upper coupler and the first side coupler.

20. The restraint system of claim 19, wherein the first upper coupler is slidably coupled to the cross arm, and the first upper coupler is configured to be secured in a fixed position on the cross arm.

21. The restraint system of claim 19, wherein the second upper coupler is slidably coupled to the cross arm, and the second upper coupler is configured to be secured in a fixed position on the cross arm.

22. The restraint system of claim 19, further comprising a second restraining loop configured to be placed around a neck of a second animal and to cross tie between the second upper coupler and the second side coupler.

23. The restraint system of claim 19, wherein the perforated support surface is raised above a bottom of the bottom frame.

24. The restraint system of claim 19, wherein a bottom of the bottom frame forms one or more flow regions for the flowing of a liquid under a top of the support surface.
